(19) United States
(12) Patent Application Publication
(10) Pub. No.: US 2003/0094536 A1
(43) Pub. Date: May 22, 2003

(54) Flyable automobile

(76) Inventor: Mitchell G. LaBiche, Friendswood, TX (US)

Correspondence Address: Rosenthal & Osha, L.L.P., Suite 2800, 1221 McKinney Street, Houston, TX, 77010, US

(21) Appl. No.: 10/281,344

(22) Filed: Oct. 25, 2002

Related U.S. Application Data
(60) Provisional application No. 60/343,847, filed on Oct. 25, 2001.

(51) Int. Cl. B64C 37/02; B64D 5/00

(52) U.S. Cl. 244/2

(57) ABSTRACT

A flyable automobile comprising a right main wing connected to the flyable automobile and comprising a right wing inner portion and a right wing outer portion, the right wing outer portion hingedly connected to the right wing inner portion so that the right wing outer portion can be folded above the right wing inner portion, and the right main wing connected to the flyable automobile so that the right main wing can pivot into a storage compartment underneath in the flyable automobile, and a left main wing connected to the flyable automobile and having a left wing inner portion and an left wing outer portion, the left wing outer portion hingedly connected to the left wing inner portion so that the left wing outer portion can be folded above the left wing inner portion, the left main wing connected to the flyable automobile so that the left main wing can pivot into the storage compartment in the flyable automobile.

### CROSS-REFERENCE TO RELATED APPLICATIONS

This application claims priority from U.S. Provisional Application No. 60/343,874, filed on Oct. 25, 2001.

### BACKGROUND OF INVENTION

Many types of vehicles have been attempted that can both fly and serve as a drivable automobile. Such vehicles are called a “roadable” airplanes, because they are planes that are able to drive on roads. Most versions include a small airplane with wings and other flight surfaces that can be folded or rotated, so as to provide a vehicle that will be small enough to drive on roads.

One such roadable airplane is described in U.S. Pat. No. 5,984,228 (“the '228 patent”) issued to Pham. The '228 patent describes a small fixed wing aircraft where a one-piece wing is rotatably mounted to the top of the fuselage. To make the vehicle road ready, the wing is rotated 90°, so that it runs along the top of the vehicle.

Another roadable airplane is described in U.S. Pat. No. 6,086,014 (“the '014 patent”) issued to Bragg. The '014 patent describes a small aircraft with wings that can be folded and rotated to a storage position along the side of the vehicle near the rear of the vehicle.

A third roadable airplane is described in U.S. Pat. No. 6,131,848 (“the '848 patent”) issued to Crow. The '848 patent describes a single seat, four wheel drive vehicle that transition into a plane for air travel. The wings are stored for road travel by rotating them by 90° and then pivoting the wings backward so they are along the side of the vehicle.

### SUMMARY OF INVENTION

One aspect of the invention relates to a flyable automobile that includes a right main wing extending from the flyable automobile and comprising a right wing inner portion and a right wing outer portion. The right wing outer portion is hingedly connected to the right wing inner portion so that the right wing outer portion can be folded above the right wing inner portion, and the right main wing is connected to the flyable automobile so that the right main wing can pivot into a storage compartment in the flyable automobile when the right wing outer portion is folded above the right wing inner portion. A flyable automobile according to this aspect of the invention also includes a left main wing extending from the flyable automobile and having a left wing outer portion and an left wing inner portion. The left wing inner portion is hingedly connected to the left wing outer portion so that the left wing outer portion can be folded above the left wing inner portion, and the left main wing is connected to the flyable automobile so that the left main wing can pivot into a storage compartment in the flyable automobile.

A flyable automobile according to this aspect of the invention may also include a right canard extending from a right front portion of the flyable automobile and hingedly connected to the flyable automobile, and a left canard extending from a left front portion of the flyable automobile and hingedly connected to the flyable automobile. Each of the canards is connected so that they can be pivoted into the front canard storage compartment on the flyable automobile. The flyable car according to this aspect may also include a right tail wing pivotally mounted to the flyable automobile on a right rear portion of the flyable automobile, and a left tail wing pivotally mounted to the flyable automobile on a left rear portion of the flyable automobile.

Another aspect of the invention relates to a retractable wing system comprising a right main wing with a right wing inner portion and an right wing outer portion, the right wing outer portion hingidly connected to the right wing inner portion so that the right wing outer portion can be folded above the right wing inner portion. A right wing box is connected to the right wing inner portion and adapted to be pivotally attached to a vehicle. A retractable wing system according to this aspect of the invention also includes a left main wing comprising a left wing inner portion and an left wing outer portion, the left wing outer portion hingedly connected to the left wing inner portion so that the left wing outer portion can be folded on top of the left wing inner portion. A left wing box is connected to the left wing inner portion and is adapted to be pivotally attached to a vehicle.

Another aspect of the invention relates to an aircraft canard system, comprising, a right canard adapted to be pivotally attached to a front section of a vehicle such that the right canard can be pivoted into a storage compartment in the vehicle. This aspect also includes a left canard that is adapted to be pivotally attached to the front section of the aircraft such that the left canard can be pivoted into the storage compartment in the vehicle.

Another aspect of the invention relates to a tail wing system comprising a right tail wing adapted to be pivotally mounted to a rear portion of a flyable vehicle, and a left tail wing adapted to be pivotally mounted to the rear portion of the flyable vehicle. The right tail wing may be adapted to pivot downward into a horizontal position, thereby forming a right half of a spoiler at the portion of the flyable vehicle, and the left tail wing may be adapted to pivot downward into a horizontal position, thereby forming a left half of the spoiler at the rear portion of the flyable vehicle.

Another aspect of the invention relates to a drive system for a flyable automobile comprising an engine, a first propeller mounted on a first propeller shaft, and a counter-rotating propeller mounded on a second propeller shaft. A first drive gear is connected to the first propeller shaft, and a second drive gear connected to the second propeller shaft. A drive shaft is operatively connected to the engine and adapted to transfer power to wheels when an engine clutch is engaged. The drive system also includes a planetary gear arrangement operatively connected to the drive shaft and a first gear set comprising at least one gear, The first gear set is operatively connected to the planetary gear arrangement and the first drive gear, and a second gear set comprising at least two gears is operatively connected to the planetary gear system and the second drive gear.

Yet another aspect of the invention relates to a method of making a flyable automobile comprising pivotally attaching a right canard to a front portion of the flyable automobile, pivotally attaching a left canard to a front portion of the flyable automobile, rotatably attaching a foldable right main wing to the flyable automobile so that the right main wing can be rotated into a right main wing storage bay under a floorboard of the flyable automobile, and rotatably attaching a foldable left main wing to the flyable automobile so that the right main wing can be rotated into a right main wing storage bay under a floorboard of the flyable automobile. A method according to this aspect may also include pivotally attaching a right tail wing to a right rear portion of the flyable automobile, and pivotally attaching a left tail wing to a left rear portion of the flyable automobile.

Other aspects and advantages of the invention will be apparent from the following description and the appended claims.

### BRIEF DESCRIPTION OF DRAWINGS

FIG. 1A shows a flyable car in car mode.

FIG. 1B shows a flyable car in airplane mode.

FIG. 1C shows controls for a flyable car.

FIG. 2A shows a flyable car in transition from car mode to airplane position with wheels extended.

FIG. 2B shows a flyable car in transition from car mode to airplane position with tail wings in a flight position.

FIG. 2C shows a flyable car in transition from car mode to airplane position with a propeller bay open.

FIG. 2D shows a flyable car in transition from car mode to airplane position with canards in a flight position.

FIG. 2E shows a flyable car in transition from car mode to airplane position with main wings rotated out of the flyable car.

FIG. 2F shows a flyable car in transition from car mode to airplane position with main wings unfolded to a flight position.

FIG. 3A shows tail wings in a road position.

FIG. 3B shows tail wings partially extended to a flight position.

FIG. 3C shows tail wings in a flight position according to one embodiment of the invention.

FIG. 3D shows tail wings in a flight position according to another embodiment of the invention.

FIG. 4A shows one aspect of a tail wing control mechanism according to one embodiment of the invention.

FIG. 4B shows another aspect of a tail wing control mechanism according to one embodiment of the invention.

FIG. 5A shows a propeller drive system accodring to one embodiment of the invention.

FIG. 5B shows a propeller gear system according to one embodiment of the invention.

FIG. 6A shows canards in a road position according to one embodiment of the invention.

FIG. 6B shows one canard in a partially unfolded position.

FIG. 6C shows two canards in a partially unfolded position.

FIG. 6D shows canards in a flight position according to one embodiment of the invention.

FIG. 7 shows one aspect of an elevator control mechanism according to one embodiment of the invention.

FIG. 8 shows another aspect of an elevator control mechanism according to one embodiment of the invention.

FIG. 9 shows a canard incidence angel control mechanism according to one embodiment of the invention.

FIG. 10A shows main wings in a road position acording to one embodiment of the invention.

FIG. 10B shows main wings partially rotated outward.

FIG. 10C shows main wings rotated outward according to one embodiment of the invention.

FIG. 11A shows a main wing with an outer portion folded over an inner portion, according to one embodiment of another aspect of the invention.

FIG. 11B shows a main wing with an outer portion in a partially folded position, according to one embodiment of another aspect of the invention.

FIG. 11C shows a main wing in an unfolded position, according to one embodiment of another aspect of the invention.

FIG. 11D shows a double pin hinge for a main wing according to one embodiment of the invention.

FIG. 12A shows one aspect of an aileron control mechanism according to one embodiment of the invention.

FIG. 12B shows another embodiment of an aileron control mechanism according to one embodiment of the invention.

### DETAILED DESCRIPTION

This invention relates to a flyable car. It is noted that while the invention is titled “Flyable Automobile,” and the description refers to a flyable car, the invention is not limited to a car. The elements and features described herein may be applied to other types of vehicles without departing from the scope of this invention. Further, the following description is related to a canard style flyable car. A canard is a small horizontal wing located near the front of the aircraft that provides vertical aircraft stability. Many of the specific features of a canard flyable car described herein may be applied to conventional canard style airplanes, or even non-canard style airplanes, without departing from the scope of this invention.

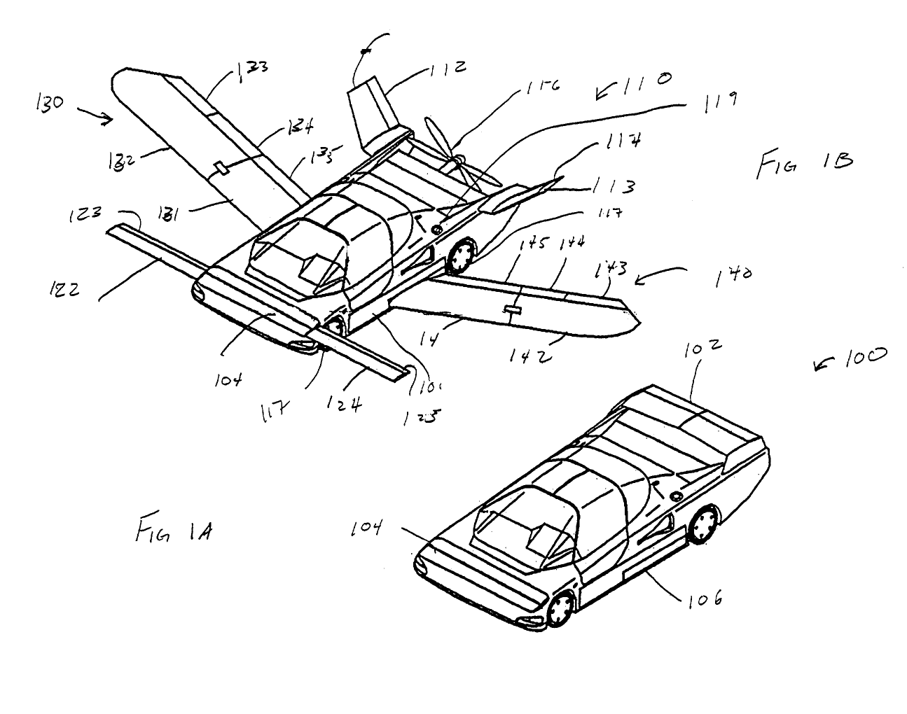

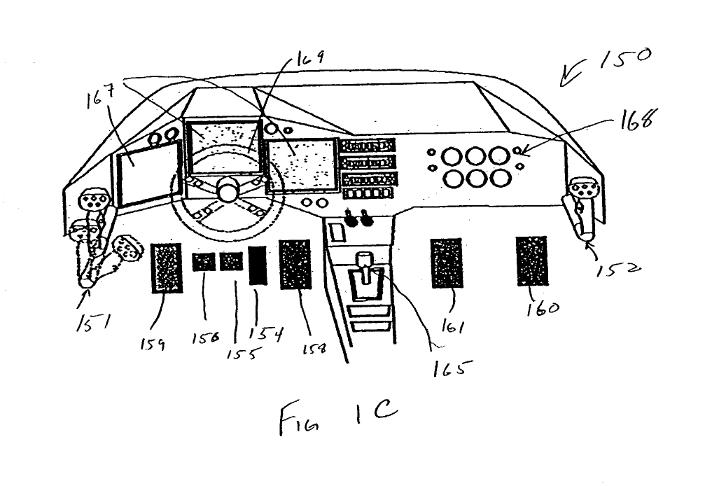

FIG. 1A shows one embodiment of a flyable car 100 according to one aspect of the invention. In this embodiment, the flyable car 100 is a high-performance sports car, although other car styles can be used with this invention. The flyable car 100 shown in FIG. 1A is in “car mode.” In car mode, the components of the flyable car 100 that enable the flyable car to fly are retracted and stored so that the flyable car 100 has the appearance of a typical car. This position of the components is called “road position.” The flyable car 100 includes a rear spoiler 102 that, as will be shown, can be deployed to form tail wings with rudders. The flyable car 100 also has canard doors 104 that enclose left and right canard wings and left and right main wing doors 106 that enclose a left and a right main wing.

FIG. 1B shows a flyable car 110 in “airplane mode.” In airplane mode, the components of the flyable car 110 that enable it to fly are all deployed so that the flyable car can fly. This position of the components is called “flight position.”

The rear spoiler (102 in FIG. 1A) has two halves that rotate upward to form a right tail wing 111 and a left tail wing 113. Each of the tail wings 111, 113 has a rudder 112, 114, respectively. The tail wings 111, 113 provide horizontal stability and yaw control for the flyable car 110 during flight. Yaw is the turning of an aircraft in the horizontal plane, similar to the turning of a car. A propeller door (not shown) opens to expose counter rotating propellers 116.

A right canard 122 and a left canard 124 are extended from the front part of the body of the flyable car 110. A canard is a horizontal wing that is mounted forward of the main wings 130, 140, as is shown in FIG. 1B. A right elevator 123 forms a rear portion of the right canard 122, and a left elevator 125 forms a rear portion of the left canard 124.

A right main wing 130 and a left main wing 140 extend from a lower portion of the flyable car 110, near the center of the flyable car 110. Each main wing may comprise two sections. For example, the right main wing 130 may comprise a right inner section 131 and a right outer section 132. Similarly, the left main wing may comprise a left inner section 141 and a left outer section 142.

Each main wing 130, 140 may include ailerons and flaps. For example, as shown in FIG. 1B, the right main wing 130 includes a right aileron 133, a right outer flap section 134, and a right inner flap section 135. In the embodiment shown in FIG. 1B, the right aileron 133 and the right outer flap section 134 are disposed on the right outer section 132, and the right inner flap section 135 is disposed on the right inner section 131. Similarly, the left main wing 140 includes a left aileron 143, a left outer flap section 144, and a left inner flap section 145. In the embodiment shown in FIG. 1B, the left aileron 143 and the left outer flap section 144 are disposed on the left outer section 142, and the left inner flap section 145 is disposed on the left inner section 141.

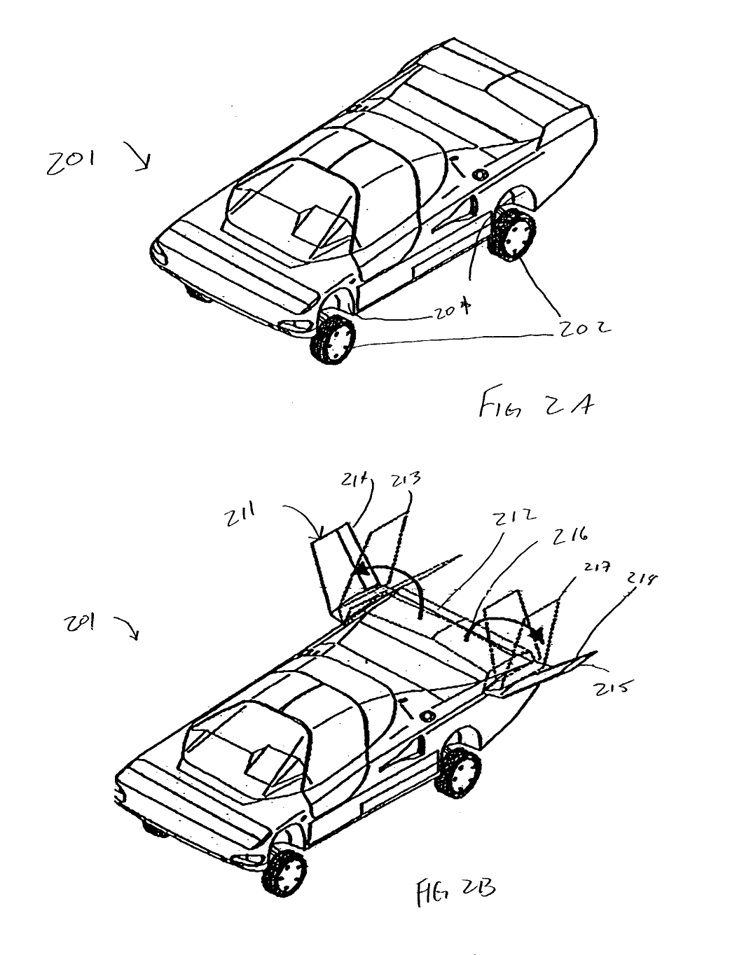

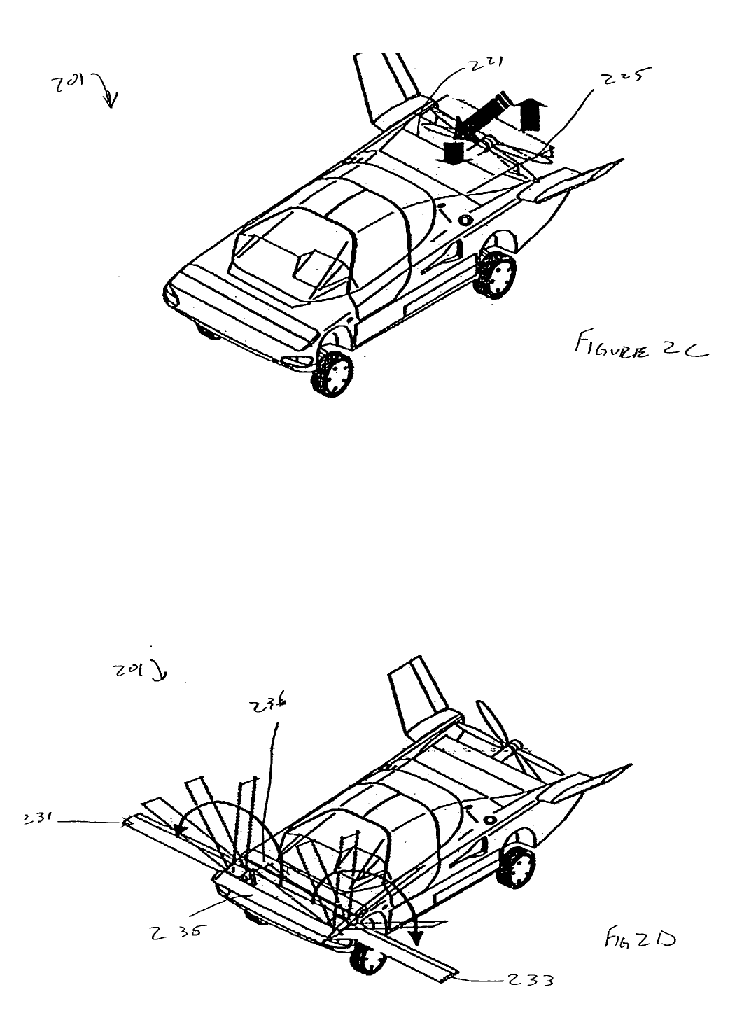

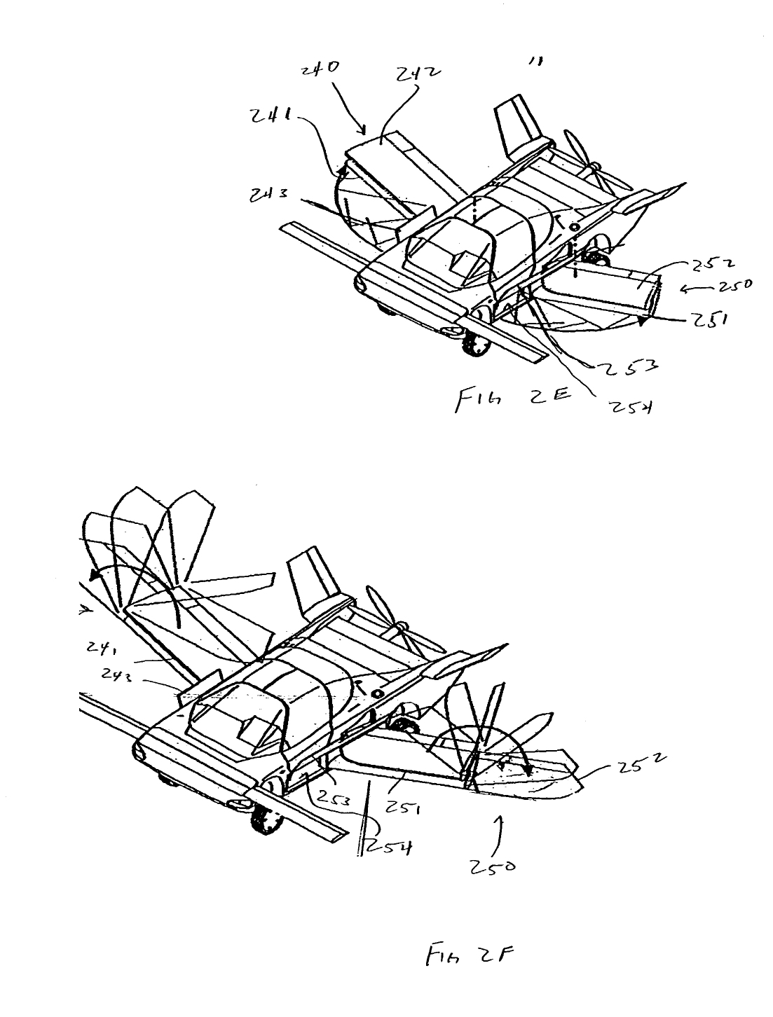

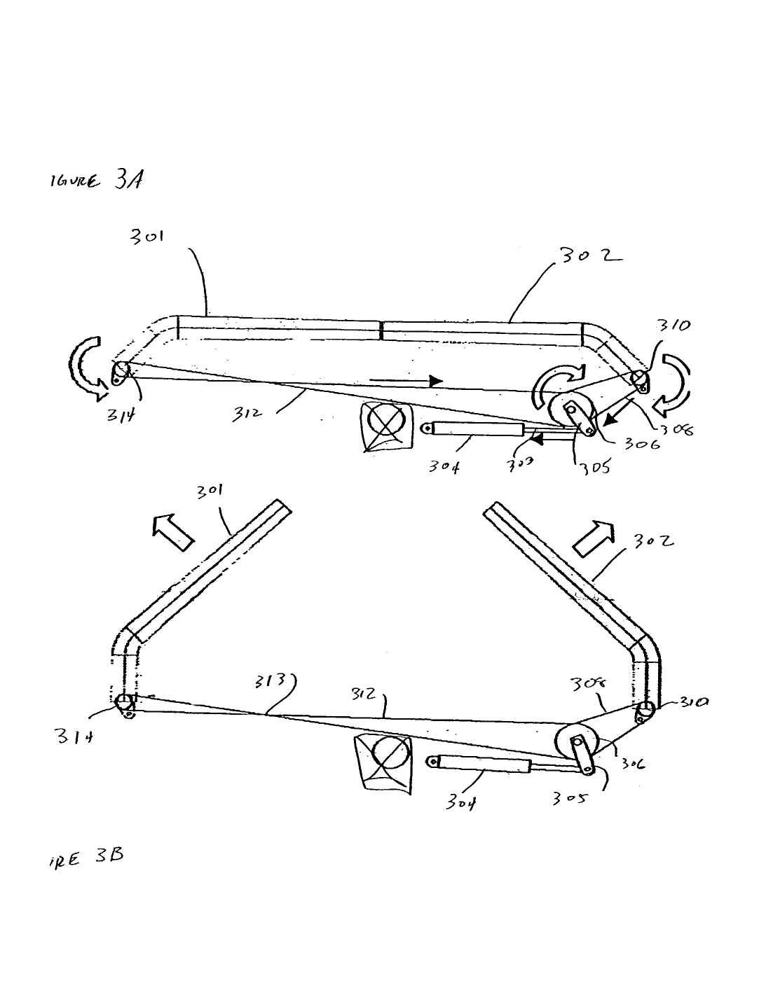

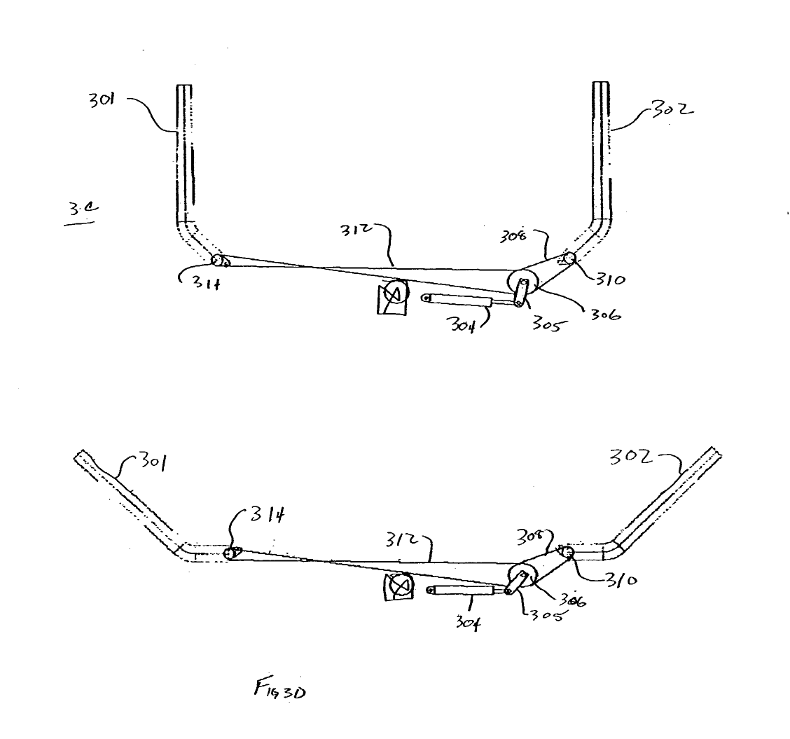

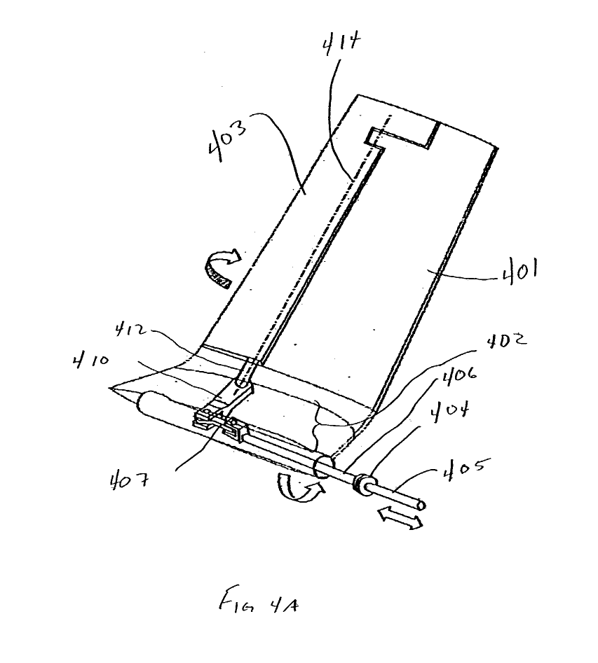

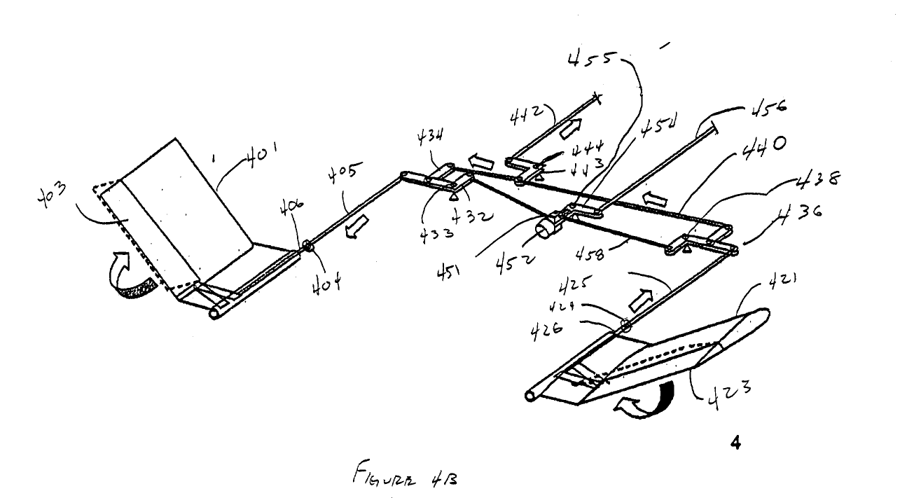

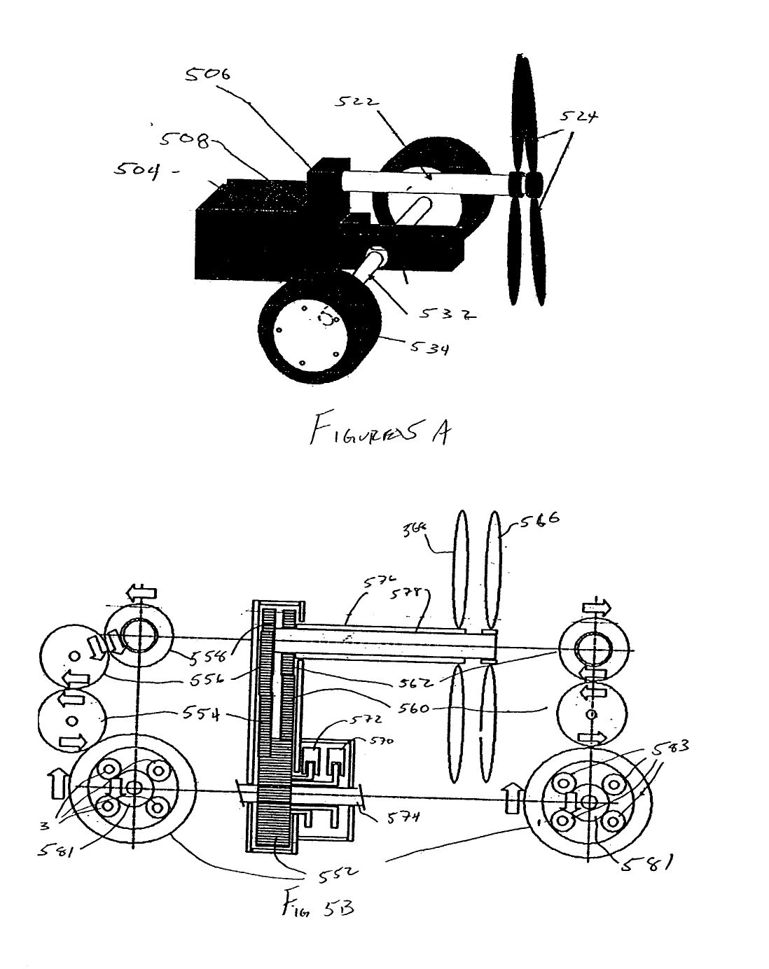

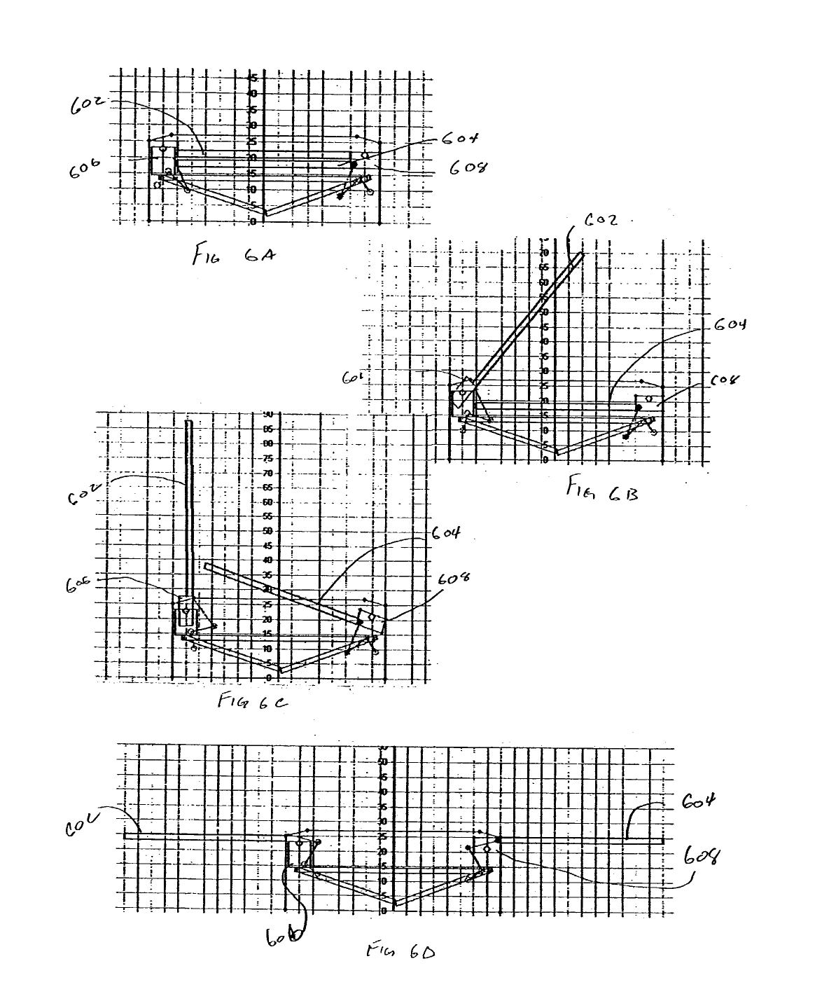

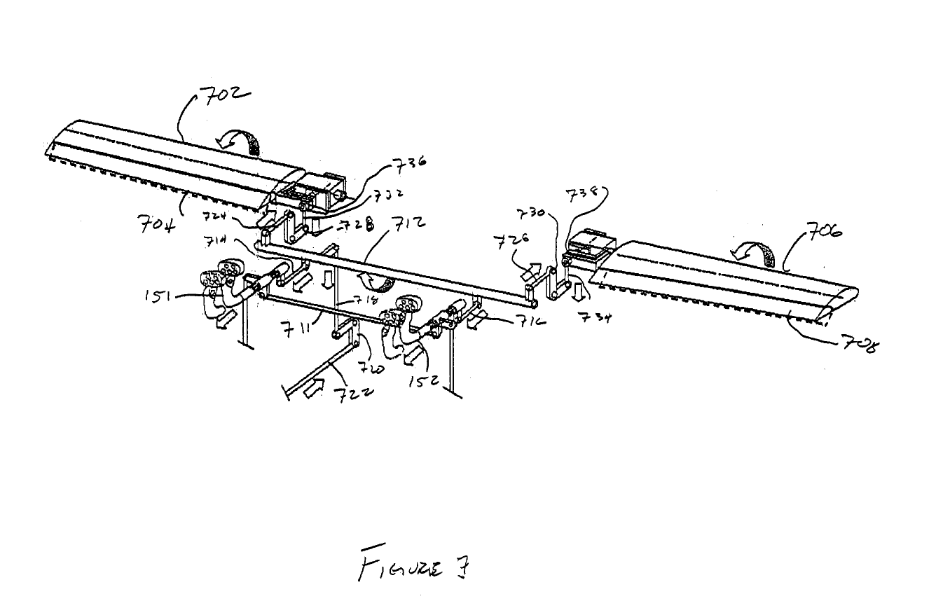

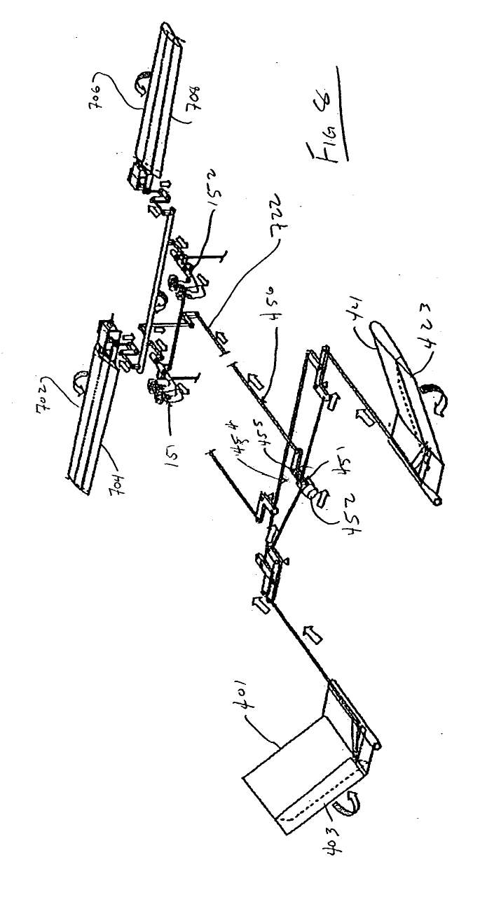

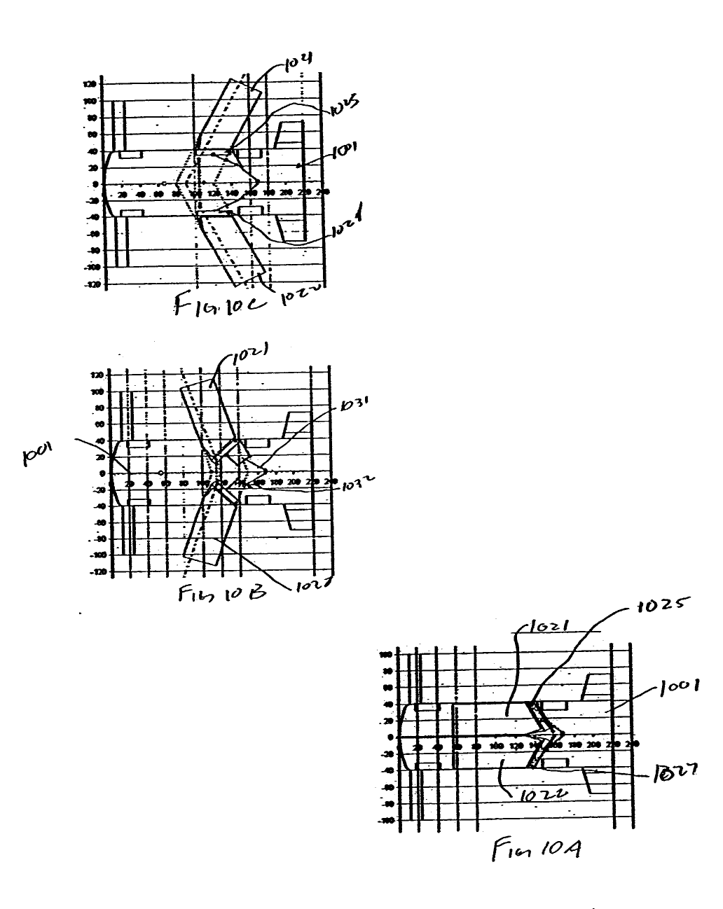

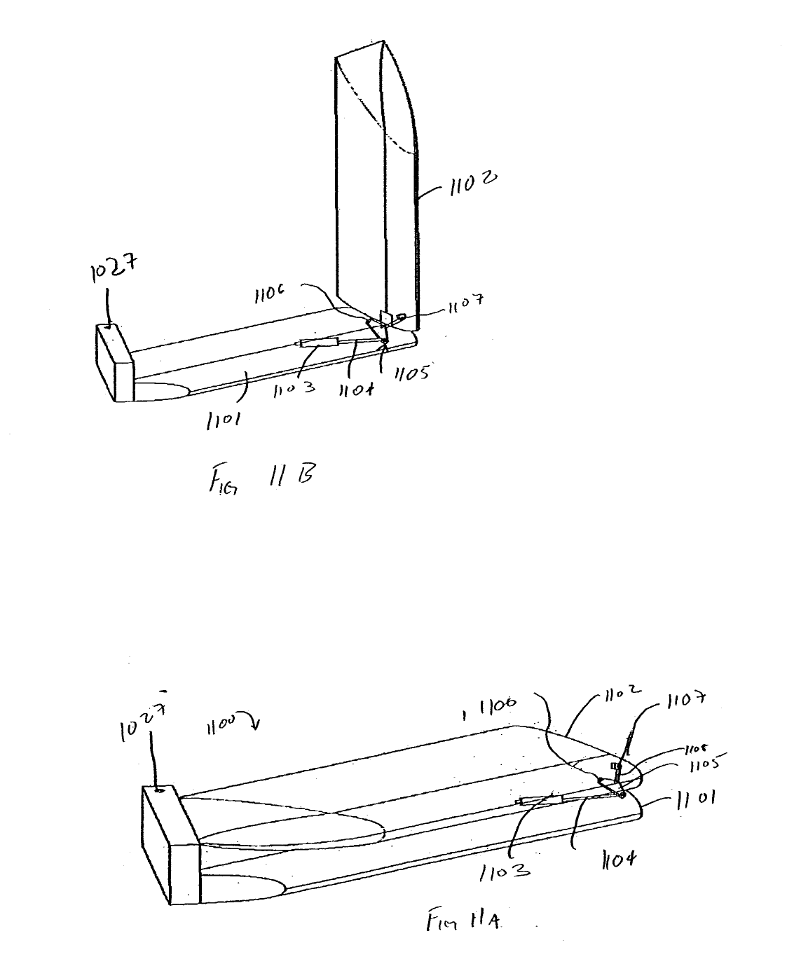

The transition from car mode, as shown in FIG. 1A, to airplane mode, as shown in FIG. 1B, will be described later with reference to FIGS. 2A-2F. Each of the components of the flyable car will be more specifically described later: the tail wings will be described with reference to FIGS. 3A-3D, 4A, and 4B; the propeller and gear system will be described with reference to FIGS. 5A and 5B; the canards will be described with reference to FIGS. 6A-6D, and 7-9; and the main wings will be described with reference to FIGS. 10A-10C, 11A-11C, 12A, and 12B. Each will be described in a separate section of this disclosure.

FIG. 1C shows one embodiment of the controls for a flyable car. The controls shown include controls necessary to drive a car and to fly an airplane. Further, in the embodiment shown, flight controls are included on the passenger side.

The control devices that may be used in car mode include standard automobile controls. The embodiment shown in FIG. 1C includes a steering wheel 169, a gear shifter 165, a gas pedal 154 or accelerator, a brake pedal 155, and a clutch pedal 156.

The flight controls include a left sidestick controller 151 on the driver's side and an right sidestick controller 152 on the passenger side. As is common in airplanes, the left sidestick controller 151 and the right sidestick controller 152 can be mechanically connected so that they move together. The flight controls also include a right rudder pedal 158 and a left rudder pedal 159. The passenger side may be equipped with alternate right 160 and left 161 rudder pedals as well.

A dash board in a flyable car may include a number of display screens 167, e.g., three, that display operating conditions to the driver/pilot. When in car mode, one or more of the display screens 167 may display information that is typically displayed in a normal car, for example, the car's speed, the engine RPM's, the fuel level, and the engine temperature. When in airplane mode, the display screens 167 may provide information necessary to fly an airplane, such as altitude, pitch, yaw, roll, airspeed, instrument navigation devices, and any other pertinent flight data.

A flyable car according to one embodiment of this invention may also include a set of conventional airplane gauges 168 on the passenger side. The gauges 168 may include standard analog gauges for altitude, aircraft orientation, airspeed, and compass direction. The passenger side controls, including the right sidestick controller 152, the right and left passenger side rudder pedals 160, 161, and the passenger side gauges 168, enable a person in the passenger seat to fly the flyable car when in airplane mode.

FIGS. 1A and 1B show a flyable car in car mode and airplane mode, respectively. FIGS. 2A-2E show stages of the transition from car mode to airplane mode. It is noted that the reverse transformation from airplane mode to car mode would involve identical steps, but in a reverse order. Only the transformation from car mode to airplane mode will be described, but those having ordinary skill in the art will understand the reverse transition process based on the following description.

FIG. 1A shows a flyable car in car mode. The first phase of the transition to airplane mode is shown in FIG. 2A. The wheels 202 of the flyable car 201 are extended from the wheel wells 204. FIG. 2A only shows the left side of the flyable car 201, but the wheels 202 on the right side are similarly extended. The wheels 202 may be extended by a hydraulic mechanism or any other means for extending the wheels of a car. For example, an electric motor with a gear may also be used. It is noted that in the transition from car mode to airplane mode, the wheels 202 are on the ground during the transition. Thus, the wheels 202 do not actually move downward, but the remainder of the flyable car 201 is raised. This reduces the ground effects on the wings (130, 140 in FIG. 1B) and prevents damage to the flyable car 201 from contact with the ground (not shown) during take-off and landing. Specifically, by raising the flyable car 201, the propeller 116 will avoid contact with the ground as the flyable car pitches upward during tale-off and landing.

FIG. 2B shows the rotating of the tail wings 211, 213 to the flight position. Both the right tail wing 211 and the left tail wing 215 start in a horizontal position (shown at 212 and 216) where they form the spoiler near the rear of the flyable car 201. During the transition to airplane mode, each of the tail wings 211, 215 rotates upward, as shown by the arrows in FIG. 2B. In some embodiments, the tail wings 211, 215 stop rotating when they reach the vertical position. The vertical position for the right tail wing 211 is shown at 213, and the vertical position for the left tail wing is shown at 217. In the vertical position, the tail wings 213, 217 will stabilize the flyable car 201 during flight, and the rudders 214, 218 can be used to control the yaw of the flyable car 201.

In other embodiments, the tail wings 211, 215 are rotated to a position past the vertical position. In one embodiment, the tail wings are rotated to form a 45° angle with the vertical. In this position, as is shown in FIG. 2B, the tail wings 211, 215 form a V-tail. The V-tail has advantages over a vertical configuration of the tail wings 211, 215. Because the V-tail is not in the vertical plane, movement of the rudders 214, 218 may affect the pitch of the flyable car 201. When the rudders 214, 218 are deflected in the same direction, that is when both are moved either to the right or to the left, they control the yaw of the flyable car. Even in a V-tail configuration, yaw control will not affect pitch because each rudder has an opposite effect from the other rudder. The pitch effects are cancelled out when the rudders are used to control yaw. But because the tail wings 211, 215 are not in a vertical position, the rudders, when deflected in opposite directions, that is both are moved inboard or both are moved outboard, the rudders affect the pitch of the flyable car 201. The tail wings and the rudders are discussed in more detail in the Tail Wing section below.

Referring to FIG. 2C, an upper door 221 and a lower door (not shown) are retracted to expose counter-rotating propellers 225. The counter-rotating propellers provide thrust for the flyable car 201 in airplane mode. The various embodiments and features of the propellers are described later in the Drive System section below.

FIG. 2D shows how a right canard 231 and a left canard 233 may be extended from the flyable car 201. A canard door 235 is opened and the canards 231, 233 are unfolded from inside the front section of the flyable car 201. In some embodiments, the canard door 235 may be closed with the canards 231, 233 in the flight position. The various embodiments and features of the canards and the canard door are discussed later in the Canard section.

The deployment of the main wings is shown in FIGS. 2E and 2F. FIG. 2E shows the right main wing 240 and the left main wing 250, which are stored underneath the flyable car 201 in car mode, and extend by rotating backwards into the flight position. A right wing door 243 opens to allow the right main wing 240 to swing out. Similarly, a left wing door 253 opens to allow the left main wing 250 to swing out. A left wing bay 254 is shown in FIG. 2E, where the left main wing 250 is stored in car mode. The right main wing 240 has a similar bay on the other side of the flyable car 201.

When the right main wing 240 is stored, and when it is being rotated either into or out of the flight position, the right outer section 242 is folded onto the top of the right inner section 241. Similarly, during storage and transition of the left main wing 250, the left outer section 252 is folded on top of the left inner section 251. By folding the outer sections 242, 252 on top of the inner sections 241, 251, the wing length is reduced, making the main wings 240, 250 easier to store under the flyable car 201.

Once the main wings 240, 250 have been rotated into the flight position, the outer sections 242, 252 are unfolded, as shown in FIG. 2F. The outer sections 242, 252 are hingedly attached to the inner sections 241, 251 of the main wings 240, 250. The outer sections 242, 252 are unfolded and locked into place. A cuff cover (not shown) may be included that slides over the notch in each main wing 240, 250, as they are unfolded. The flyable car 201 is then ready for take-off.

After take off, the wheels 117 may be retracted, as shown in FIG. 1B, for better flight characteristics. This completes the transition from car mode, as shown in FIG. 1A, to airplane mode, as shown in FIG. 1B.

Tail Wings

In one or more embodiments, the tail wings (111 and 113 in FIG. 1B) are the vertical stabilizers for the flyable car when it is in airplane mode. When in car mode, the tail wings (111 and 113 in FIG. 1B) are folded down to form a spoiler at the rear portion of the car. Each tail wing forms one half of the spoiler. The deployment and control of the tail wings are described in this section with specific reference to FIGS. 3A-3D, 4A, and 4B.

FIGS. 3A-3D show the deployment of the tail wings 301, 302. It is noted that the retraction of the tail wings 301, 302, i.e., from the flight position to the road position, may be accomplished in the reverse order of what is described below.

FIG. 3A shows the tail wings 301, 302 as viewed from the front of the car looking backwards. The right tail wing 301 is so called because it is on the right side of the flyable car (not shown in FIG. 3A). The right tail wing 301 and the left tail wing 302 are in a horizontal position, i.e., the road position, forming a spoiler on the flyable car in car mode.

In one embodiment, the tail wing drive mechanism is comprised of an actuator 304, a crank 305, a drive pulley 306, a left tail wing cable 308, a left tail wing tube 310, a right tail wing cable 312, and a right tail wing tube 314. The left tail wing tube 310 is attached to the left tail wing 302 near its base, and the left tail wing tube 310 is collinear with the point of rotation of the left tail wing 302. With the left tail wing tube 310 in this position, the left tail wing 302 can be rotated by the application of a torque to the left tail wing tube 310. The right tail wing 301 and the right tail wing tube 314 are similarly arranged.

The actuator 304 causes the tail wings 301, 302 to deploy by pivoting about the tail wing tubes 310, 314. The actuator 304 can be an electric actuator, a hydraulic actuator, or any other type of actuator known in the art. The actuator 304 shown in FIGS. 3A-3D is an electric linear actuator that controls the tail wings 301, 302 by extending and retracting an actuator linkage member 303. The actuator 304 is connected to a crank 305 that is connected to a drive pulley 306. When the actuator 304 applies a force to the crank 305, the drive pulley 306 is rotated by the force.

Left tail wing cable 308 is connected to both the drive pulley 306 and the left tail wing tube 310. As the drive pulley 306 is rotated, the left tail wing cable 308 drives the left tail wing tube 310 to rotate in the same direction as the drive pulley 306, and the left tail wing 302 pivots upward.

The right tail wing cable 312 is connected to both the right tail wing tube 314 and the drive pulley 306. Because the right tail wing 301 is on the opposite side of the flyable car (not shown) from the left tail wing 302, the right tail wing tube 314 must rotate in the opposite direction from the left tail wing tube 310 so that the right tail wing 301 pivots in the proper direction. To accomplish this, the right tail wing cable 312 has a crossover 313 that causes the right tail wing tube 314 to rotate in a direction opposite to the direction of the drive pulley 306. Alternatively, a gear may be coupled to the tail wing tube to change the rotation direction without the crossover 313.

FIG. 3B shows the tail wings 301, 302 in an intermediate position. The actuator 304 has caused the drive pulley 306 to rotate and the cables 308, 312 have driven the tail wings 301, 302 to pivot upward. FIG. 3C shows the tail wings 301, 302 after a 90° pivot from the original horizontal position. The tail wings 301, 302 are in a vertical position, like tail wings on other standard aircraft. In at least one embodiment, the airplane mode includes the tail wings 301, 302 in the vertical position. In other embodiments, for example, the embodiment shown in FIG. 3D, the tail wings 301, 302 are positioned 45° past the vertical, or 135° of total outward rotation from the original horizontal position. In this position, the tail wings 301, 302 form a V-tail. As will be discussed later with reference to FIG. 4B, a V-tail is advantageous because, by pivoting the rudders in opposite directions, that is, either both outboard or both inboard, the V-tail may provide additional pitch authority. The tail wings 301, 302 may be locked into place by any suitable locking device, for example, tapered locking pins (not shown).

The actuator 304 may be controlled by a number of different mechanisms. The control mechanism could be a computer controlled device that controls the deployment of the tail wings in the sequence of the transition from car mode to airplane mode. The actuator could also be controlled by a switch near the pilot.

The above description represents only one embodiment of a tail wing drive mechanism. Many other embodiments are possible without departing from the scope of this invention. For example, each tail wing could have a separate actuator and the mechanism may not include a drive pulley and cables. In another example, the left tail wing cable could have a crossover and the right tail wing tube could rotate in the same direction as the drive pulley. Further, the cables could be attached to the tail wings in a manner that does not include tubes. Those having skill in the art will realize that there are many other ways to drive the tail wings.

FIGS. 4A and 4B show a mechanism for controlling the rudders on the tail wings. The primary purpose of the rudders is to control the yaw of the flyable car. FIG. 4A shows only the left tail wing 401, but it will be appreciated that the mechanisms for controlling the right tail wing (not shown) are similar.

The left rudder 403 may be located near the rear of the left tail wing 401. The left rudder 403 affects the flyable car (not shown) by deflecting out of the plane of the left tail wing 401. In the embodiment shown in FIG. 4A, the left rudder 403 pivots along axis 414.

The left rudder 403 may be controlled by the motion of left rudder control tube 405. The left rudder control tube 405 may be connected to the left rudder push-pull tube 406 by a swivel bearing 404 that enables the left rudder push-pull tube to rotate with the left tail wing 401 when it is pivoted, while the left rudder control tube 405 does not rotate.

It is noted that many of the members in the control systems described in this specification are described as tubes. In some embodiments, the control members are tubes. A tube provides excellent strength characteristics, but the hollow inside allows the tube to have minimal weight. Although some members are described as tubes, they are not intended to be limited to tubes. Those having skill in the art will be able to devise other control system members, without departing from the scope of the invention.

As the left rudder control tube 405 is moved along its axis, the force is transmitted through the swivel bearing 404 and to the left rudder push-pull tube 406. The left push-pull tube 406 is connected to the left rudder drive crank 410 by the left rudder linkage 407. The left rudder drive crank 410 is located in the short-angled segment 402 of the left tail wing 401. The left rudder drive crank 410 is connected to and makes about a 45° angle with the left rudder rotation tube 412. As the left rudder push-pull tube 406 is moved, the left rudder drive crank 410 pivots about the axis of the left rudder rotation tube 412, thereby causing the left rudder 403 to deflect in the corresponding direction.

FIG. 4B shows how the rudders 401, 421 are controlled from inside the flyable car (not shown). The rudder pedal control tube 442 is connected to the rudder pedals (not shown) in such a way that the rudder pedal control tube 442 moves forward when the left rudder pedal (not shown) is depressed, and the rudder pedal control tube 442 moves rearward when the right rudder pedal is depressed. The rudder control tube 442 can be connected to the rudder pedals by any method known in the art.

The rudder control mechanism will now be described for the situation when the left rudder pedal is depressed. It is understood that the description for when the right rudder pedal is depressed is similar, but with the components moving in opposite directions.

When the left rudder pedal (not shown) is depressed, the rudder control tube 442 moves toward the front of the flyable car (not shown). The rudder control tube 442 is connected to bell crank 443, which pivots about point 444. As a result of the forward motion of the rudder control tube 442, the bell crank 443 causes the rudder linkage tube 440 to move to the left. (Note: a “bell crank” is a device that changes the direction of a force or a movement. There are several bell cranks shown in the rudder and other control mechanisms. Because of the number of bell cranks included in some embodiments, many are only identified by their reference number in the figures.) The movement of the rudder linkage tube 440 causes movement in two other bell cranks, left bell crank 432 and right bell crank 436. The left bell crank 432 rotates about fixed axis 432 and pushes the left rudder control tube 405 toward the rear of the flyable car. The right bell crank is rotated about fixed axis 438 and causes the right rudder control tube 425 to move toward the front of the flyable car. The movement of the rudder control tubes 405, 425 controls the rudders 403, 423 in the manner described above with respect to FIG. 4A.

FIG. 4B also shows a mechanism for pitch control through a V-tail. The rudder-pitch control mechanism includes a pitch control tube 456 connected to the sidestick controllers (151, 152 in FIG. 1C) on one end and to an elevator control crank 454 on the other end. A pitch control member 458 is attached at the other end of the elevator control crank 454 by a connecting linkage 451. Forward movement of the pitch control tube 456 causes a counter-clockwise rotation of the elevator control crank 454, which causes a movement of the pitch control member 458 toward the right of the flyable car (not shown). The right bell crank 436 and the left bell crank 434 have an opposite orientation so that they will each rotate in an opposite direction in response to a movement of the pitch control tube 456. For example, when the pitch control tube 456 is moved forward, the elevator control crank 454 rotates counter clock-wise, the pitch control member 458 moves to the right, the left rudder crank 434 rotates clockwise, and the right rudder crank 436 rotates counter clockwise. The result is that the left rudder control tube 405 and the right rudder control tube 425 are both moved in the same direction, namely forward, and the left rudder 401 and the right rudder 421 deflect in the same direction, namely inboard. This causes an increase in the flyable car's pitch, i.e., it causes the tail to go down relative to the nose.

The pitch control tube 456 is connected to the elevator control mechanism that controls the elevators on the canard. One method for connecting the pitch control tube 456 to the elevator control mechanism is described below in the Canard section.

Drive System

In one or more embodiments, the drive system is the mechanism that delivers power to the propeller and the wheels of the flyable car. The drive system may comprise an engine, a propeller gear system, an engine clutch, and a transaxle.

The propellers provide the thrust for the flyable car when it is in the air. In some embodiments, the propellers comprise two counter-rotating propellers, although other embodiments of the propellers are possible without departing from the scope of this invention. In some embodiments, the propellers include a variable pitch mechanism. The pitch of the propellers can be controlled by an electric or a hydraulic mechanism, as is known in the art.

Referring back to FIG. 2C, counter rotating propellers 225 are positioned at the rear of flyable car 201. In car mode, the counter-rotating propellers can be locked in the horizontal position, i.e., the road position, so that they can be enclosed by a propeller cover 221. During the transition from car mode to airplane mode, the cover 221 is retracted and the propellers are exposed.

FIG. 5A shows the drive mechanism for the propellers 524. The drive mechanism may include an engine 504, a propeller speed reduction unit 506, an engine clutch 508, and a transaxle 510.

The engine 504 is any suitable engine that supply power to both the car mode and the airplane mode. One such engine is the Porsche 930 turbo engine. This engine is a 3.6 liter, air-cooled engine similar to the engine used in the Porsche powered Mooney airplane. This engine, and other similar engines, are ideal for use with a flyable car.

In car mode, the engine 504 drives the rear wheels 534 through the transaxle 510. The transaxle 510 may be any automotive transaxle that is suitable for the size and weight of the particular vehicle. The engine clutch 508 disengages the engine 504 from the transaxle 510 when the gears are being shifted.

Engine power is transferred to the propellers 524 through a propeller speed reduction unit 506. FIG. 5B shows a schematic of a propeller speed reduction unit 506. A preferable speed reduction ratio is about 2.3:1, reducing an engine speed of 5500 RPM to a propeller speed of 2400 RPM. Those having skill in the art will realize that engines with various speeds could be used and that other propeller speeds may be desirable, depending on the design of the aircraft. Other speed reduction ratios are possible, without departing from the scope of the invention.

As shown in FIG. 5B, the propeller speed reduction unit 506 may use a planetary gear assembly along with transfer gears. The sun gear 581 drives a set of planetary gears 583. The sun gear 581 may be connected to the drive shaft 574 of the engine. The planetary gears 583 may be connected to a carriage (not shown) that holds the planetary gears 583 in a fixed position relative to each other. The planetary gear carriage may be connected to first brake 570 that prevents the rotation of the planetary gears 583.

When the first brake is engaged, the planetary gears 583 may drive a ring gear 552, that drives two sets of transfer gears, each providing power to a different one of the counter-rotating propellers 566, 568. The first gear set 554, 556, and 558 provide power to the outer propeller 566 through inner shaft 578. The second gear set 560 and 562 provide power to the inner propeller 568 through outer shaft 576. In some embodiments, gears 554 and 556 on the first set of transfer gears and gear 560 on the second set of transfer gears are the same size. This enables the propellers 566, 568 to rotate in opposite directions, i.e., counter-rotating, while still having the same speed reduction ratio.

The transfer of power from the engine (504 in FIG. 5A) to the propellers 566, 568 may be controlled by two brakes, the first brake 570 and the second brake 572. The first brake 570, when engaged, locks the planetary gear carriage (not shown) and the planetary gears 583 in place. Thus, when the first brake 570 is not engaged, the planetary gears 583 are free to rotate without driving the ring gear 552. When the first brake 570 is engaged, however, the planetary gears 583 drive the ring gear, and power may be transferred to the propellers 566, 568. The second brake 572, when engaged, prevents the ring gear 552, and thus the propellers 566, 568 from rotating. The second brake may be used to stop the rotation of the propellers 566, 568 and lock them in the horizontal position.

In a normal take-off, the flyable car (not shown) will transition from car mode to airplane mode, including changing the flyable car's drive mechanism. The engine clutch (506 in FIG. 5A) will be opened so that no power is transferred to the rear wheels 534, and the rear wheels 534 are free to rotate as the flyable car (not shown) moves along the ground. The first brake 570 is engaged to lock the planetary gears 583, and the second brake 572 is disengaged so that the ring gear 552 is free to rotate. When the driver/pilot applies power, the thrust from the propellers 566, 568 pushes the flyable car (not shown) down a runway (not shown), until the flyable car (not shown) reaches take-off speed. At that time, the flyable car (not shown) may become airborne. The propellers 566, 568 are the thrust mechanisms during flight.

In some embodiments, the flyable car (not shown) is capable of a powered-assist take-off. During a powered-assist take-off, the engine (504 in FIG. 5A) provides power to the rear wheels (534 in FIG. 5A) during the take-off acceleration, e.g., 0 mph-60 mph. During this period, the first brake is disengaged so that the planetary gears 583 are free to rotate without driving the ring gear 552. The second brake may be engaged to prevent the propellers 566, 568 from rotating, or, in some embodiments, the second brake may be released so that the propellers 566, 568 are free to rotate.

In a transition mode, e.g., 60 mph-75 mph, power is delivered simultaneously to both the rear wheels (534 in FIG. 5A) and the propellers 566, 568. The engine clutch (506 in FIG. 5A) is engaged so that power is transferred to the rear wheels (534 in FIG. 5A). The second brake 572 must be released so that the ring gear 552, and thus the propellers 566, 568, is free to rotate. The first brake 570 is engaged and prevents the planetary gears 583 from rotating. By engaging the first brake 570, the planetary gears 583 drive the ring gear 552, which in turn, drives the propellers 556, 568. Thus, both the rear wheels (534 in FIG. 5A) and the propellers 566, 568 simultaneously power the flyable car in a transition mode.

As the flyable car (not shown) nears take-off speed, the engine clutch (506 in FIG. 5A) is opened and power is transmitted to only the propellers 566, 568. Table 1 provides a summary of the different modes of propulsion for one embodiment of the invention.

TABLE 1

| | | | | | Rear | |
|---|---|---|---|---|---|---|
| | Speed | Brake | Brake | Transaxle | Wheel | Propeller |
| Mode | (MPH) | #1 | #2 | Clutch | Status | Status |
| Car | 0-275 | OFF | ON | Engaged | Powered | Stopped |
| | | | | | | Hori- |
| | | | | | | zontally |
| Take-off | 0-60 | OFF | OFF | Engaged | Powered | Free |
| Acceleration | | | | | | Spinning |
| Transition | 60-75 | ON | OFF | Engaged | Powered | Powered |
| Airplane | 75+ | ON | OFF | Open | Stopped/ | Powered |
| | | | | | Retracted | |

Specific embodiments of a propeller and gear system that can be used with a flyable car have been described. Those having skill in the art will be able to devise other systems without departing from the scope of the invention.

Canards

In one or more embodiments, the canards provide pitch stability and pitch control to the flyable car. They also provide a portion of the lift that enables a flyable car to fly. The canards themselves act as air foils to provide lift and stabilize the pitch of the flyable car. Pitch control is achieved through elevators that are disposed on the canards. One of the advantages of a canard style aircraft, as will be described, is that it can be made “stall proof,” that is, it can be made so that it cannot slow down to less than the main wing stall speed.

Referring back to FIG. 2D, the canards 231, 233, when in the flight position, extend to each side from the front of the flyable car 201. FIG. 2D also shows canard clamshell doors 235, 236 that close to protect the canard when retracted into the flyable car 201. When retracted, the canards 231, 233 are stored in a front canard storage compartment. The doors 235, 236 open so that the canards 231, 233 can be deployed. The canard doors 235, 236 may then close so that the canards 231, 233 are locked into place and flyable car 201 has better aerodynamic properties. In another embodiment (not shown), the canard door is a single member that opens by pivoting up and toward the front of the car. A single canard door may be extended to the open position to serve as an air brake or to serve as a spoiler during landing.

FIGS. 6A-6D show a deployment of the canards 602, 604. In the embodiment shown, the canards 602, 604 are stacked inside the flyable car (not shown) and they unfold to the flight position.

In FIG. 6A, both the right canard 602 and the left canard 604 are retracted inside the flyable car (not shown), i.e., they are in the road position. (Note: The right canard 602 and the left canard 604 are named such because of the side of the car, relative to a forward facing driver/pilot, that each extends from. FIGS. 6A-6D are views from the front, i.e., looking toward the rear, of the flyable car.) Using, for example, electric actuators, the canards 602, 604 are sequentially unfolded from inside the flyable car (not shown).

FIG. 6B shows the right canard 602 is partially unfolded from the flyable car, and the left canard 604 has not yet begun to unfold. When the right canard 602 reaches the vertical position, or a 90° rotation, the left canard 604 is able to begin to unfold, as is shown in FIG. 6C. Finally, as shown in FIG. 6D, both the right canard 602 and the left canard 604 are fully unfolded and in the flight position.

The right canard 602 and its unfolding actuator are a mirror image of the left canard 604 and its unfolding mechanism, except for the right 606 and left 608 canard mounting blocks. The mounting blocks 606, 608 have pivot points that are offset by the canard thickness so that the canards 602, 604 will be at the same height when deployed, or in the flight position, but will stack up when folded into the flyable car (not shown) for easier storage in the road position.

Also, the unfolding is just one method of canard deployment. Those having skill in the art will be able to devise other canard deployment mechanisms and methods (e.g., swing outward) without departing from the scope of this invention.

FIG. 7 shows one embodiment of an elevator control mechanism. The elevators 704, 708 are located on the canards 702, 706 and are controlled by forward and backward movement of the sidestick controllers 151, 152. The left sidestick controller 151 and the right sidestick controller 152 are linked by a sidestick linkage 711. Any forward or rearward movement or rotation of either sidestick controller, e.g., the left sidestick controller 151, will cause the same movement in the other sidestick controller, e.g., the right sidestick controller 152.

The sidestick controllers 151, 152 are connected to an elevator torque tube 712. The right sidestick controller 151 is connected to the elevator torque tube 712 by a left elevator-stick linkage 714, and the right sidestick controller 152 is connected to the elevator torque tube 712 by a right elevator-stick linkage 716. A forward or rearward movement of the sidestick controllers 151, 152 will cause a corresponding rotation of the elevator torque tube 712. The rotation of the elevator torque tube 712 causes a corresponding movement in left linkage tube 724, rotation in left bell crank 728, and movement in vertical left linkage tube 732. Vertical left linkage tube 732 is connected to the left elevation offset crank 736, which, when rotated, causes deflection of the left elevator 704.

Movement of the sidestick controllers 151, 152 causes a deflection in the right elevator 708 by a similar mechanism. The rotation of elevator torque tube 712 causes a movement in right linkage tube 726, a rotation of right elevator bell crank 730, and a movement of right linkage 734. Vertical right linkage 734 is connected to the right elevator offset crank 738, which deflects the right elevator 708.

The embodiment of the elevator control mechanism shown in FIG. 7 is designed so that a rearward movement of the sidestick controllers 151, 152 will result in a downward deflection of the elevators 704, 708. A downward deflection of the elevators will cause the nose of the flyable car to pitch upward, i.e., the pitch will increase. A forward movement of the sidestick controllers 151, 152 will cause an upward deflection of the elevators 704, 708 and a decrease in pitch.

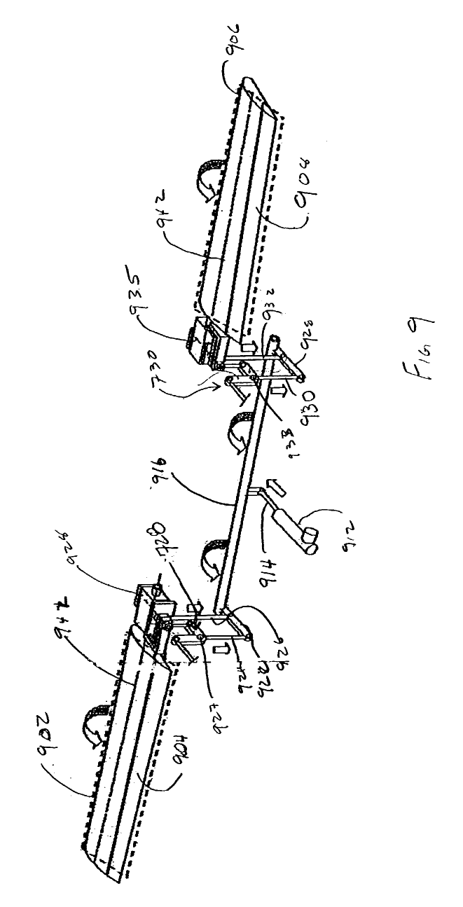

FIG. 8 shows one embodiment of a connection between an elevator control system, for example, the elevator control system shown in FIG. 7, and a rudder control system, for example the rudder control system shown in FIG. 4B. The pitch control tube 456 of the rudder control system is connected to the rudder-pitch control tube 722 of the elevator control system. When the connecting linkage pivot point 451 is spaced apart from the pivot point 455 of the rudder-elevator control bell crank 454, forward and rearward movements of the sidestick controllers 151, 152 will cause a deflection of the left 403 and right 423 rudders, as was described with reference to FIG. 4B. The movement of the rudders 403, 423 will either be away from each other, i.e., both outboard, or it will be toward each other, i.e., both inboard. When, on the other hand, the connecting linkage pivot point 451 is moved by the actuator 452 so that the pivot point 451 is directly above the pivot point 455 of the rudder-elevator control bell crank 454, the movement of the pitch control tube 456 does not affect the deflection of the rudders 403, 423.

The deflection of the rudders 403, 423 caused by a forward or rearward movement of the sidestick controllers 151, 152 when the connecting linkage pivot point 451 is moved away from the rudder-elevator bell crank 454 pivot point 455 is in the opposite direction of the deflection of the elevators 704, 708. Thus, if the sidestick controllers 151, 152 are pulled backward, the elevators 704, 708 would deflect downward and the rudders 403, 423 would deflect inboard, or slightly upward due to the angle of the V-tail. Both deflections increase the pitch of the flyable car (not shown). The actuator 452 can be controlled so that the rudders provide more pitch authority when needed.

FIG. 9 shows a canard incidence angle control system. The canard incidence angle is the angle that the canards 902, 904 make with respect to the flyable car (not shown). The incidence angle of the canards 902, 904 may be changed to a more advantageous position, depending on the particular flight situation. For example, an increased canard incidence angle is beneficial at slow landing speeds, because the higher incidence angle will generate more lift. Also, a lower canard incidence angle will provide a canard stall speed that is faster than the main wing stall speed. This is advantageous because the canards will stall before the main wings, causing the nose to pitch downward and the speed to increase. The main wings cannot reach stall speed, and the aircraft is said to be “stall proof.”

An actuator 912, for example, a linear electric actuator, controls the incidence angle by moving control rod 914, which is connected to canard incidence torque tube 916. As the canard incidence torque tube 916 rotates, it moves the canard incidence vertical control members. There are four such control members, with two on each side. The left front canard incidence control member 926 is attached, on its upper end, to the left canard inner offset crank 928. The left rear canard incidence control member 924 is connected to the pivot point 927 of the left bell crank 728. By connecting both the left bell crank 728 and the left canard inner offset crank 928 to the canard incidence torque tube 916, the incidence angle of the left canard 902 can be changed without affection the deflection of the left elevator 904 with respect to the left canard 902. The right canard 906 is controlled in the same way using the right front 932 and rear 930 canard incidence control members attached to the right canard inner offset crank 933 and the pivot point 730 of the right bell crank 935. The use of the front 932 and rear 930 canard incidence control members enables the incidence angle of the right canard 906 to be changed without changing the deflection of the elevator 908 relative to the canards 906.

In one embodiment, the canards 902, 906 are mounted on a tubes that run through the quarter chords 941, 942 of the each canard 902, 906. By positioning the mounting tubes at the quarter chord, the incidence angle of the canards 902, 906 can be changed-during flight-with a small amount of force from the linear actuator 912.

Main Wings

The main wings provide the majority of the lift that enables a flyable car to fly. Advantageously, the main wings can be stored completely within the flyable car when in car mode. In the transition from car mode to airplane mode, the main wings are extended and unfolded, as will be described below. In some embodiments, the main wings may be extended by rotating the wings toward the rear of the flyable car. As will also be described, this feature enables the main wings to be slightly rotated forward when the flaps are lowered, thereby increasing aircraft stability. The main wings may also contain gas tanks for a flyable car.

Referring back to FIGS. 2E and 2F, the main wings 240, 250 may be deployed by pivoting them from a storage position in a wing compartment 254 below the floorboard (not shown) of the flyable car 201. The storage compartment may be a single main wing storage compartment, or it may be separated into a right main wing storage compartment and a left main wing storage compartment. The wing bay doors 243, 253 open to allow the main wings 240, 250 to pivot outward. After the main wings 240, 250 are pivoted outward, the deployment may also include unfolding the outer portions 242, 252 of the wings 240, 250 from a storage position on top of the inner wing portions 241, 251. Once the main wings 240, 250 are fully deployed, the wing bay doors 243, 253 may be at least partially closed over the portions where the main wings 240, 250 are not connected to the flyable car 201.

FIGS. 10A-10C show the main wings 1021, 1022 pivoting outward from the flyable car 1001. In FIG. 10A, the right main wing 1021 is stored under the flyable car 1001 on the right side. The left main wing 1022 is also stored under the flyable car 1001, but under the left side. FIG. 10B shows the right main wing 1021 and the left main wing 1022 partially pivoted outward from the flyable car 1001. The main wings 1021, 1022 may be driven by linear actuators 1031, 1032 connected to a linkage and a bell crank. The actuators 1031, 1032 are connected to the right 1023 and left 1024 main wing boxes (see FIG. 10C) that transfer the bending and torsion loads of the wing to the flyable car 1001. FIG. 10C shows the main wings 1021, 1022 fully pivoted outward. The main wing 1021, 1022 may then be locked in the flight position in preparation for flight.

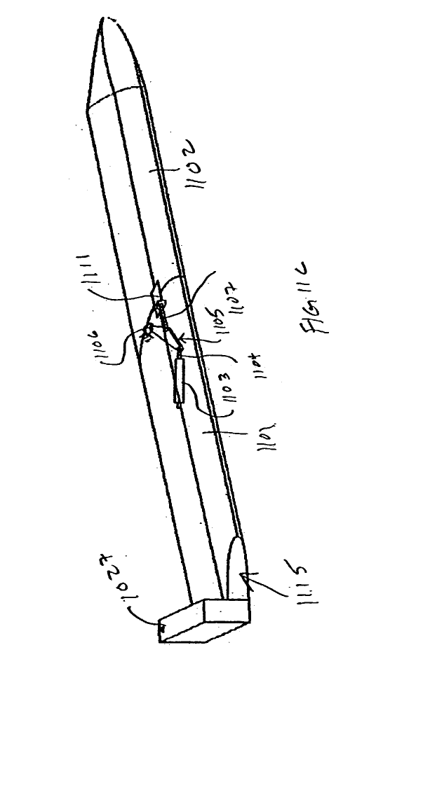

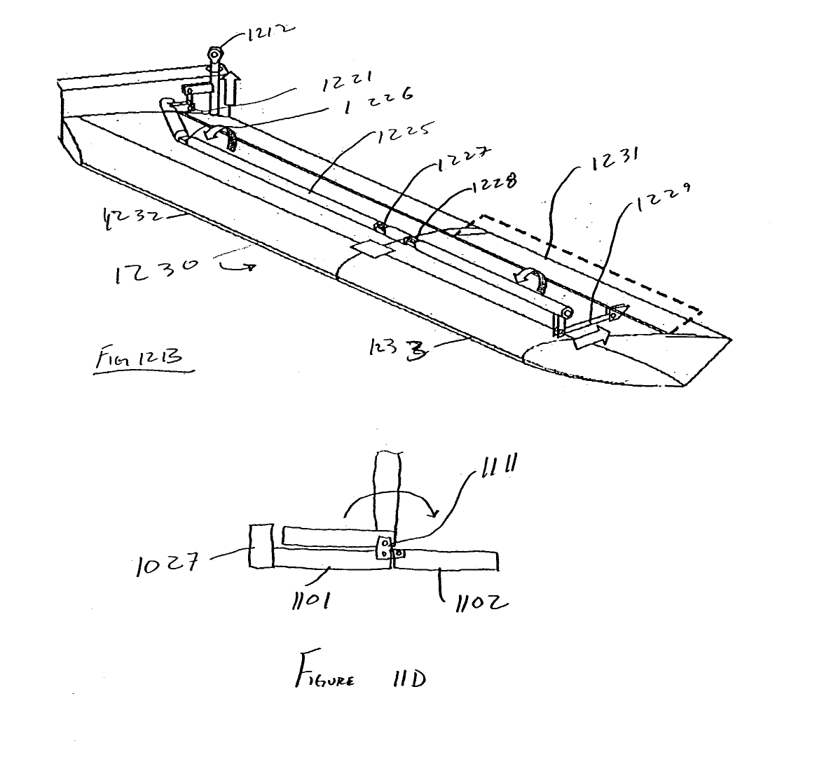

FIGS. 11A-I IC show an embodiment of mechanism for unfolding the outer portion of the main wings 1102 (Note: the embodiment in FIGS. 11A-11C shows only one main wing, but the figures illustrate the mechanism for both wings-each side being a mirror image of the other. The following description applies equally to the right and the left main wings. Thus, no right or left distinction is made in this description.). In FIG. 11A, the outer portion 1102 of the main wing 1100 is folded above the inner portion 1101. An actuator 1103 is connected by a linkage tube 1104 to the main wing bell crank 1105, which has a fixed pivot point 1106. An outer portion linkage 1107 is connected between the main wing bell crank 1105 and the outer portion 1102 of the main wing 1100. Again, the actuator 1103 may be any suitable type of actuator, for example, an electric linear actuator.

When the actuator 1103 retracts the linkage tube 1104, the outer portion 1102 begins to unfold. FIG. 1B shows the outer wing 1102 unfolded about 90°, or half way. In FIG. 11C, the linear actuator 1104 has fully retracted, and the outer portion 1102 is fully unfolded, or in the flight position. The unfolding of the outer portion 1102 is enabled by a double pin hinge, such as the one shown in FIG. 11D, for example. The inner portion 1101 and the outer portion 1102 may be locked in place using, for example, two locking lugs (not shown) on the bottom of the main wing 1100.

The inner portion 1101 of the main wing 1100 may also include a wing root cover (not shown) to cover the notch 1115 (best seen in FIG. 11C) that each main wing 1100 must have so that there is no interference when both wings are pivoted inward to the car mode. The cover would slide over the notch 1115 to create a better wing shape. Such a cover may be spring loaded to slide inward and cover the notch and it may include a cable to retract it when the outer portion is not in the unfolded position.

In some embodiments, the main wings also include flaps (134, 135, 144, and 145 in FIG. 1B). The flaps can be controlled and actuated by any mechanism known in the art. In certain of these embodiments, the main wings rotate forward when the flaps are extended. This has the effect of decreasing the rearward movement of the center of pressure that is associated with extending the flaps. This provides for a more stable aircraft.

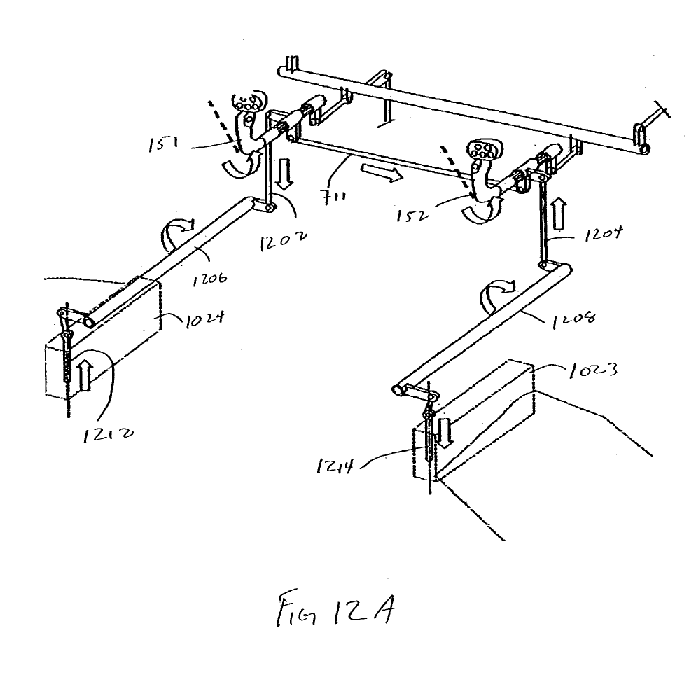

The ailerons (133, 143 in FIG. 1B) are mounted on the main wings (130, 140 in FIG. 1B) and control the roll of the flyable car. One embodiment of a mechanism for controlling the ailerons (133, 143 in FIG. 1B) is shown in FIGS. 12A and 12B. FIG. 12A shows that the left 151 and right 152 sidestick controllers are connected to the left 1202 and right 1204 aileron linkages, respectively. The left aileron linkage 1202 is connected to the left aileron control tube 1206, which is, in turn, connected to left aileron control pin 1212. Similarly, the right aileron linkage 1204 is connected to the right aileron control tube 1208, which in connected to the right aileron control pin 1214. Each of the aileron control pins 1212, 1214 is aligned to be collinear with the pivot joints (1025, 1027 in FIG. 10A) in the main wing boxes (1023, 1024 in FIG. 10C.). This enables the controls to remain attached to the wing during deployment, retraction, and when stored in road position.

The aileron control system is designed so that the sidestick controllers 151, 152 cause the right aileron control pin 1214 to move in the opposite direction from the left aileron control pin 1212. For example, turning either sidestick controller 151 or 152 to the left will cause the left aileron control pin 1212 to move upward and the right aileron control pin 1214 to move downward.

FIG. 12B shows the aileron control system within the left main wing 1230. It is understood that the aileron control system within the right main wing would be a mirror image of the system in the left main wing.

The left aileron control pin 1212 is connected to the left aileron torque tube 1225 by a left torque tube linkage 1221. Movement of the left aileron control pin 1212 causes a corresponding rotation of the let aileron torque tube 1225. The left aileron torque tube 1225 is connected to the left aileron 1231 by the left aileron linkage 1229. The rotation of the left aileron torque tube 1225 causes a corresponding defection of the left aileron 1231 with respect to the left main wing 1230.

Depending on the direction of the deflection, the left aileron 1231 affects either an increase or a decrease in the lift generated by the left main wing 1230. An upward deflection affects a decrease in the lift, whereas a downward deflection affects an increase in lift. The right aileron control pin 1214 moves in an opposite direction from the left aileron control pin 1212. Because the left 1212 and right 1214 aileron control pins move in opposite directions, the left and right ailerons (140, 150 in FIG. 1B) have opposite effects on the lift generated by their respective wings. A decrease in the lift generated by the left main wing coupled with an increase in the lift generated by the right main wing will cause the flyable car to roll to the left side. Conversely, a decrease in the lift generated by the right main wing coupled with an increase in the lift generated by the left main wing will cause the flyable car to roll to the right side.

In one embodiment, the left aileron torque tube 1225 includes three universal joints 1226, 1227, and 1228. The first universal joint 1226 alters the direction of the left aileron torque tube 1225 to be parallel with the left main wing 1230. The second 1227 and third 1228 universal joints enable the outer portion 1233 of the left main wing 1230 to be folded onto the inner portion 1232 without having to disconnect the control linkage.

Referring back to FIG. 1B, the main wings 130, 140 may also include fuel tanks (not shown) for the flyable car 201. This enables the space normally occupied by a fuel tank to be used for main wing storage. The fuel tanks (not shown) may be connected to the gas inlet nozzle 119 by flexible tubing (not shown).

Advantageously, embodiments of the invention provide for a flyable car with flight surfaces, i.e., the main wings, the canards, and the propellers, that are stored within the flyable car when in car mode. This greatly reduces the risk of having critical flight equipment damaged when the flyable car is being used as a road vehicle. Also, certain embodiments of a flyable car include a powered-assist take-off that reduces the length of runway required for take-off. Further, because the main wings and the canards may be stored within the flyable car, the flyable car, when in car mode, appears to be a normal car. As such, it will not draw unnecessary and dangerous attention from other drivers.

A flyable car according to one or more embodiments of the invention may have no sliding flight surfaces. This reduces the wear and tear on the wings and canards when the flyable car is transitioned from car mode to airplane mode.

Another possible advantage for one or more embodiments of the invention is enabled by the main wing rotation. Because the main wings are connected to an actuator for rotating them between the road position and the flight position, they can also be slightly rotated forward during flight. The increased lift caused by extending the flaps can be compensated for by rotating the main wings slightly forward. Doing so creates a more stable aircraft. This is especially advantageous during landing.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A flyable automobile, comprising:
a right canard extending from a right front portion of the flyable automobile and hingedly connected to the flyable automobile so that the right canard can be pivoted into a front canard storage compartment on the flyable automobile;
a left canard extending from a left front portion of the flyable automobile and hingedly connected to the flyable automobile so that the left canard can be pivoted into the front canard storage compartment on the flyable automobile;
a right tail wing pivotally mounted to the flyable automobile on a right rear portion of the flyable automobile and having a right rudder disposed thereon;
a left tail wing pivotally mounted to the flyable automobile on a left rear portion of the flyable automobile and having a left rudder disposed thereon, the right tail wing and the left tail wing able to pivot inward to the road position and from a spoiler on a rear portion of the flyable automobile;
a hydraulic system operatively coupled to wheels on the flyable automobile and adapted to extend the wheels below the flyable automobile;
at least one propeller disposed at a rear of the flyable automobile and operatively connected to an engine in the flyable automobile;
a right main wing extending from a lower right portion of the flyable automobile and comprising a right wing inner portion and a right wing outer portion, the right wing inner portion hingedly connected to the right wing outer portion so that the right wing outer portion can be folded above the right wing inner portion, the right main wing connected to the flyable automobile so that the right main wing can pivot to a road position in a storage compartment underneath a right side of a floorboard of the flyable automobile; and
a left main wing extending from a lower left portion of the flyable automobile and having a left wing inner portion and an left wing outer portion, the left wing inner portion hingedly connected to the left wing outer portion so that the left wing outer portion can be folded above the left wing inner portion, the left main wing connected to the flyable automobile so that the left main wing can pivot to a road position in a storage compartment underneath a left side of the floorboard in the flyable automobile.

2. A flyable automobile, comprising:
a right main wing connected to the flyable automobile and comprising a right wing inner portion and a right wing outer portion, the right wing outer portion hingedly connected to the right wing inner portion so that the right wing outer portion can be folded above the right wing inner portion, and the right main wing connected to the flyable automobile so that the right main wing can pivot into a storage compartment underneath in the flyable automobile; and
a left main wing connected to the flyable automobile and having a left wing inner portion and an left wing outer portion, the left wing outer portion hingedly connected to the left wing inner portion so that the left wing outer portion can be folded above the left wing inner portion, the left main wing connected to the flyable automobile so that the left main wing can pivot into the storage compartment in the flyable automobile.

3. The flyable automobile of claim 2, wherein the storage compartment is disposed beneath a floorboard of the flyable automobile.

4. The flyable automobile of claim 2, further comprising:
a right canard extending from a right front portion of the flyable automobile and hingedly connected to the flyable automobile so that the right canard can be pivoted into a front canard storage compartment on the flyable automobile; and
a left canard extending from a left front portion of the flyable automobile and hingedly connected to the flyable automobile so that the left canard can be pivoted into the front canard storage compartment on the flyable autmobile.

5. The flyable automobile of claim 3, further comprising a canard door that encloses the front canard storage compartment when in a closed position.

6. The flyable automobile of claim 5, wherein the canard door is a clamshell door.

7. The flyable automobile of claim 5, wherein the canard door is single member hingidly connected to the flyable automobile.

8. The flyable automobile of claim 2, further comprising:
a right tail wing pivotally mounted to the flyable automobile on a rear portion of the flyable automobile; and
a left tail wing pivotally mounted to the flyable automobile on the rear portion of the flyable automobile, the right tail wing able to pivot inward to a horizontal and form a right half of a spoiler on the rear portion of the flyable automobile, and the left tail wing able to pivot inward to a horizontal position and form a left half of a spoiler on the rear portion of the flyable automobile.

9. The flyable automobile of claim 8, wherein the right tail wing and the left tail wing extend vertically when in a flight position.

10. The flyable automobile of claim 8, wherein the right tail wing is rotated 135 degrees outward from the horizontal position when in a flight position and the left tail wing is rotated 135 degrees outward from the horizontal position when in a flight position.

11. The flyable automobile of claim 2, further comprising a hydraulic system operatively coupled to wheels on the flyable automobile and adapted to extend the wheels below the flyable automobile.

12. The flyable automobile of claim 2, further comprising at least one propeller disposed at a rear of the flyable automobile and operatively connected to an engine in the flyable automobile.

13. The flyable automobile of claim 12, wherein the at least one propeller comprises two counter rotating propellers.

14. A retractable wing system, comprising:
a right main wing comprising a right wing inner portion and an right wing outer portion, the right wing outer portion hingidly connected to the right wing inner portion so that the right wing outer portion can be folded above the right wing inner portion;
a right wing box connected to the right wing inner portion and adapted to be pivotally attached to a vehicle;
a left main wing comprising a left wing inner portion and an left wing outer portion, the left wing outer portion hingedly connected to the left wing inner portion so that the left wing outer portion can be folded above the left wing inner portion; and
a left wing box connected to the left wing inner portion and adapted to be pivotally attached to the vehicle.

15. The retractable wing system of claim 14, wherein the right main wing is adapted to pivot forward when flaps are extended, and the left main wing is adapted to pivot forward when flaps are extended.

16. The retractable wing system of claim 14, wherein the right main wing comprises a right aileron and the left main wing comprises a left aileron.

17. An aircraft canard system, comprising:
a right canard adapted to be pivotally attached to a front section of a vehicle such that the right canard can be pivoted into a storage compartment in the vehicle; and
a left canard adapted to be pivotally attached to the front section of the vehicle such that the left canard can be pivoted into the storage compartment in the vehicle.

18. The canard system of claim 17, wherein the right canard is mounted by a right mounting tube that runs through a quarter chord of the right canard, the right canard attached to the aircraft in such a way that an incidence angle of the right canard can be adjusted by rotating the right mounting tube, and wherein the left canard is mounted by a left mounting tube that runs through a quarter chord of the left canard, the left canard attached to the aircraft in such a way that an incidence angle of the left canard can be adjusted by rotating the left mounting tube.

19. A tail wing system, comprising:
a right tail wing adapted to be pivotally mounted to a rear portion of a flyable vehicle; and
a left tail wing adapted to be pivotally mounted to a left rear portion of the flyable vehicle, the right tail wing adapted to pivot downward into a horizontal position, thereby forming a right half of a spoiler at the rear portion of the flyable vehicle and the left tail wing adapted to pivot downward into a horizontal position, thereby forming a left half of the spoiler at the rear portion of the flyable vehicle.

20. The tail wing system of claim 19, wherein the right tail wing comprises a right rudder and the left tail wing comprises a left rudder.

21. The tail wing system of claim 19, wherein the right tail wing is adapted to be mounted such that it can be pivoted upward to a vertical position and the left tail wing is adapted to be mounted such that it can be pivoted upward to a vertical position.

22. The tail wing system of claim 19, wherein the right tail wing is adapted to be mounted such that it can be pivoted outward to a position past a vertical position, and the left tail wing is adapted to be mounted such that it can be pivoted outward to a position past a vertical position.

23. The tail wing system of claim 22, wherein the right tail wing is adapted to be mounted to rotate 135 degrees outward from the horizontal position, and the left tail wing is adapted to be mounted to rotate 135 degrees outward from the horizontal position.

24. A drive system for a flyable automobile, comprising:
an engine;
a first propeller mounted on a first propeller shaft;
a counter-rotating propeller mounded on a second propeller shaft;
a first drive gear connected to the first propeller shaft;
a second drive gear connected to the second propeller shaft;
a drive shaft operatively connected to the engine and adapted to transfer power to wheels when an engine clutch is engaged;
a planetary gear arrangement operatively connected to the drive shaft;
a first gear set comprising at least one gear, the first gear set being operatively connected to the planetary gear arrangement and the first drive gear; and
a second gear set comprising at least two gears, the second gear set being operatively connected to the planetary gear system and the second drive gear.

25. The drive system of claim 24, wherein the planetary gear arrangement comprises a sun gear, a ring gear, and a plurality of planetary gears disposed between the sun gear and the ring gear.

26. The drive system of claim 25, further comprising a first brake that, when engaged, prevents the planetary gears from rotating, and a second brake that, when engaged, prevents the ring gear from rotating.

27. The drive system of claim 24, wherein the drive system is adapted to selectively drive at least one of the rear wheels and the propellers.

28. The drive system of claim 27, wherein the drive system is adapted to simultaneously drive the rear wheel and the propellers.

29. The drive system of claim 24, wherein the first gear set and the second gear set have the same speed reduction ratio.

30. A method of making a flyable automobile, comprising:
pivotally attaching a right canard to a front portion of the flyable automobile;
pivotally attaching a left canard to a front portion of the flyable automobile;
rotatably attaching a foldable right main wing to the flyable automobile so that the right main wing can be rotated into a right main wing storage bay under a floorboard of the flyable automobile;
rotatably attaching a foldable left main wing to the flyable automobile so that the right main wing can be rotated into a right main wing storage bay under a floorboard of the flyable automobile;
pivotally attaching a right tail wing to a right rear portion of the flyable automobile; and
pivotally attaching a left tail wing to a left rear portion of the flyable automobile.
